(19) United States
(12) Patent Application Publication
(10) Pub. No.: US 2014/0115876 A1
(43) Pub. Date: May 1, 2014

(54) MANUFACTURING METHOD OF SEGMENT COIL

(71) Applicants: Ichiro OKADA, Toyota-shi (JP); Hiroaki URANO, Miyoshi-shi (JP)

(72) Inventors: Ichiro OKADA, Toyota-shi (JP); Hiroaki URANO, Miyoshi-shi (JP)

(73) Assignee: TOYOTA JIDOSHA KABUSHIKI KAISHA, Toyota-shi (JP)

(21) Appl. No.: 14/064,460

(22) Filed: Oct. 28, 2013

(30) Foreign Application Priority Data
Oct. 31, 2012 (JP) 2012-239992

(51) Int. Cl. H02K 15/04

(52) U.S. Cl. CPC H02K 15/0421
USPC 29/596

(57) ABSTRACT

A manufacturing method of a segment coil includes i) bending a wire assembly in which a plurality of conducting wires are twisted together in a manner such that the conducting wires are able to slide with respect to one another, and ii) compression molding the bent wire assembly.

### INCORPORATION BY REFERENCE

The disclosure of Japanese Patent Application No. 2012-239992 filed on Oct. 31, 2012 including the specification, drawings and abstract is incorporated herein by reference in its entirety.

### BACKGROUND OF THE INVENTION

1. Field of the Invention

The invention relates to a manufacturing method of a segment coil formed by a wire assembly formed by a plurality of bundled conducting wires.

2. Description of Related Art

A segment coil is used as a coil that is assembled to a stator core. A segment coil, also referred to as a segment conductor (SC), is formed by a series of split bodies (segments) assembled to a stator core.

The segment coil is formed to be a predetermined shape. For example, as shown in FIG. 5, a segment coil 100 is formed in a general U-shape, and includes a pair of leg portions 102a and 102b, and a folded-back portion 104 that connects the leg portions 102a and 102b together. The leg portions 102a and 102b are inserted between teeth 108 of a stator core 106. The folded-back portion 104 becomes a coil end that protrudes out from the stator core 106.

The segment coil 100 may be formed by a wire assembly in which a plurality of conducting wires are bundled together, as in Japanese Patent Application Publication No. 2008-193860 (JP 2008-193860 A), Japanese Patent Application Publication No. 2008-186724 (JP 2008-186724 A), Japanese Patent Application Publication No. 2009-199749 (JP 2009-199749 A), and Japanese Patent Application Publication No. 2009-153291 (JP 2009-153291 A). JP 2009-153291 A describes a process for manufacturing a segment coil from a wire assembly. According to this, a wire assembly in which a plurality of conducting wires are bundled together is compression molded, and adjacent conducting wires are fixed together. Then the compression molded wire assembly is bent is several places to form the folded-back portion 104.

### SUMMARY OF THE INVENTION

However, when the coil end largely protrudes from the stator core 106, the physical size of the entire stator becomes that much larger. In order to minimize the amount of protrusion of the coil end, it is desirable to reduce a bending radius R (curvature radius) of a bent portion 110 that is at a base of the folded-back portion 104, as shown in FIG. 6.

However, when bending a wire assembly that has been compression molded, if the bending radius R is reduced, bending stress may cause the conducting wires to peel away from the wire assembly. As shown in FIG. 7, when conducting wires 112 and 114 that have been fixed together are bent, compression stress is generated in the conducting wire 112 on the inner peripheral side of the wire assembly. The compression stress and the bending radius R are inversely proportionate, so when the bending radius R is made smaller, the compression stress increases. If the compression stress increases, a portion of the conducting wire 112 on the inner peripheral side may buckle and bend, and peel away from the fixed surface, as shown in FIG. 8.

In order to inhibit the conducting wire from buckling, it is possible to bend the wire assembly before compression molding, i.e., before fixing the conducting wires together, as described in Japanese Patent Application Publication No. 2012-165624 (JP 2012-165624 A), for example. However, the unfixed wire assembly may come apart. Therefore, the manufacturing process until the wire assembly is fixed, such as a worker holding the wire assembly so that it does not come apart, may be troublesome.

Therefore, the invention provides a manufacturing method of a segment coil that enables the bending radius to be smaller, while inhibiting the wire assembly from coming apart.

One aspect of the invention relates to a manufacturing method of a segment coil that uses a wire assembly formed by a plurality of conducting wires. This manufacturing method includes bending the wire assembly in which the plurality of conducting wires are twisted together in a manner such that the conducting wires are able to slide with respect to one another, and compression molding the bent wire assembly.

The manufacturing method according to this aspect of the invention may also include coating the compression molded wire assembly with an insulating film.

According to the invention, when manufacturing a segment coil, it is possible to reduce the bending radius, while inhibiting the wire assembly from coming apart.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a perspective view of a segment coil according to one example embodiment of the invention.

FIG. 2 is a view of a bundling process;

FIG. 3 is a view of a bending process;

FIG. 4 is a view of a compressing process;

FIG. 5 is a view of a segment coil according to related art;

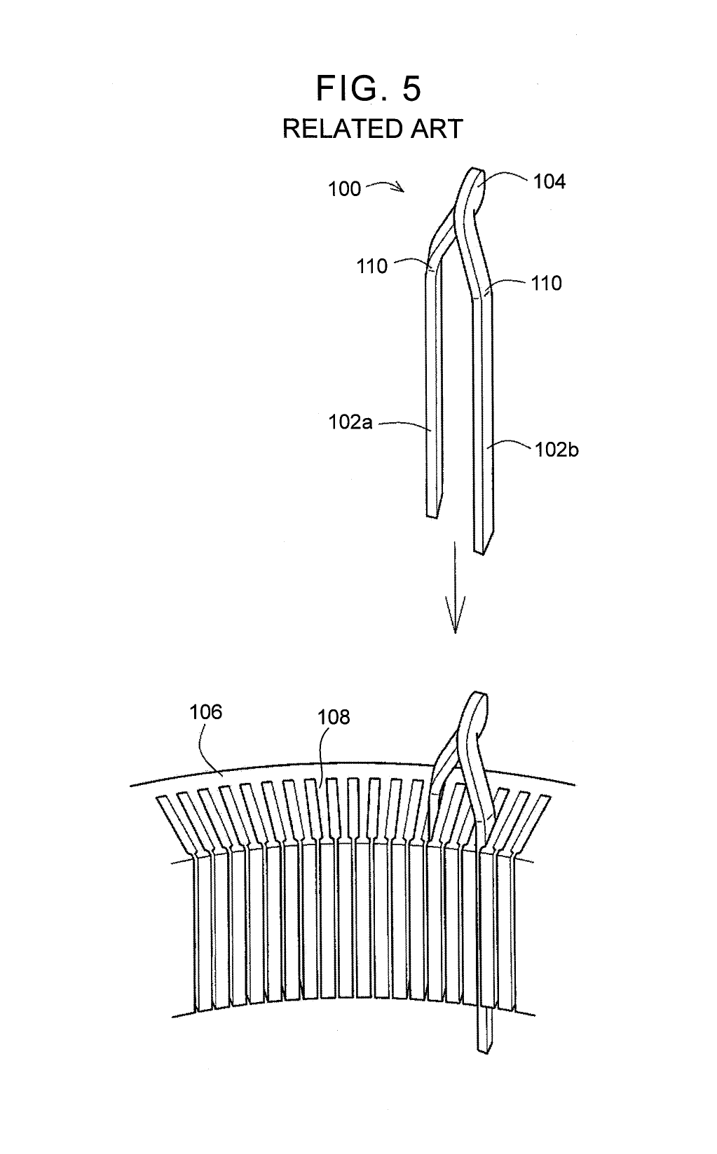

FIG. 6 is a view illustrating a bending radius;

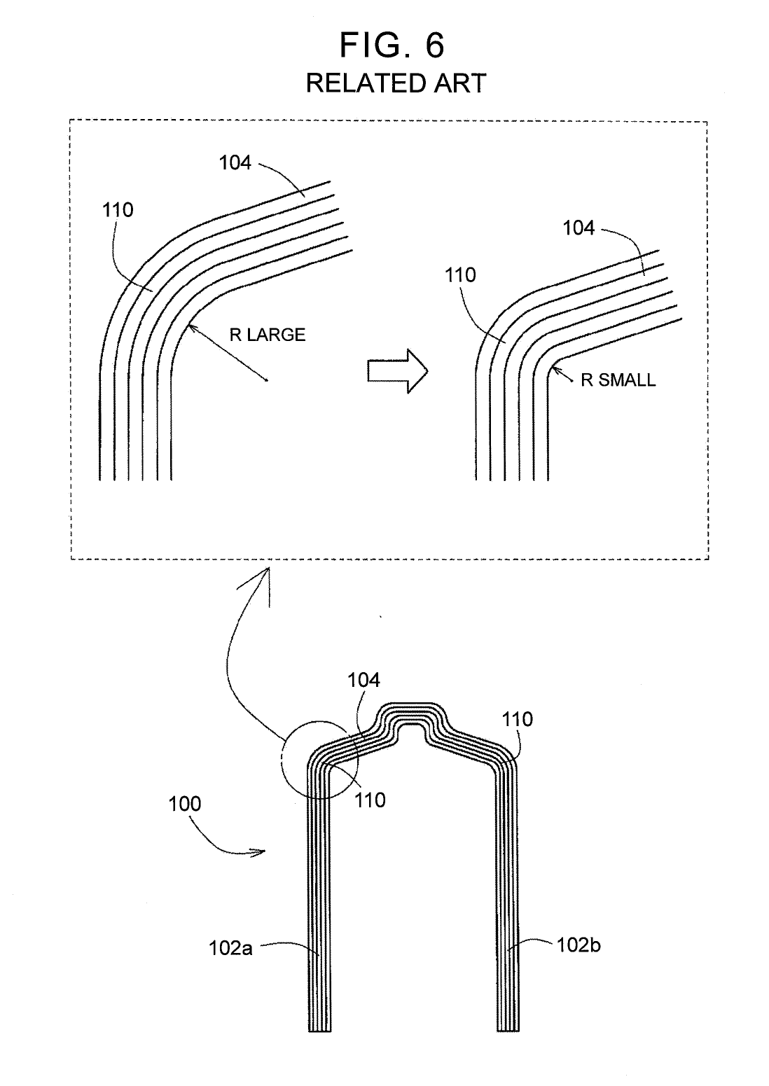

FIG. 7 is a view showing a frame format of bending stress when bending the segment coil; and

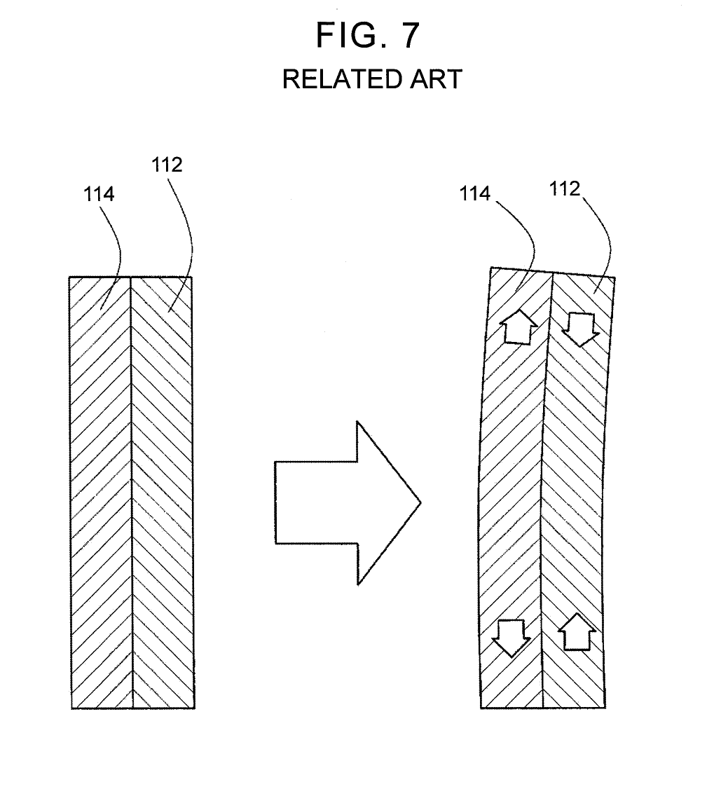

FIG. 8 is a view showing a frame format of conducting wires buckling.

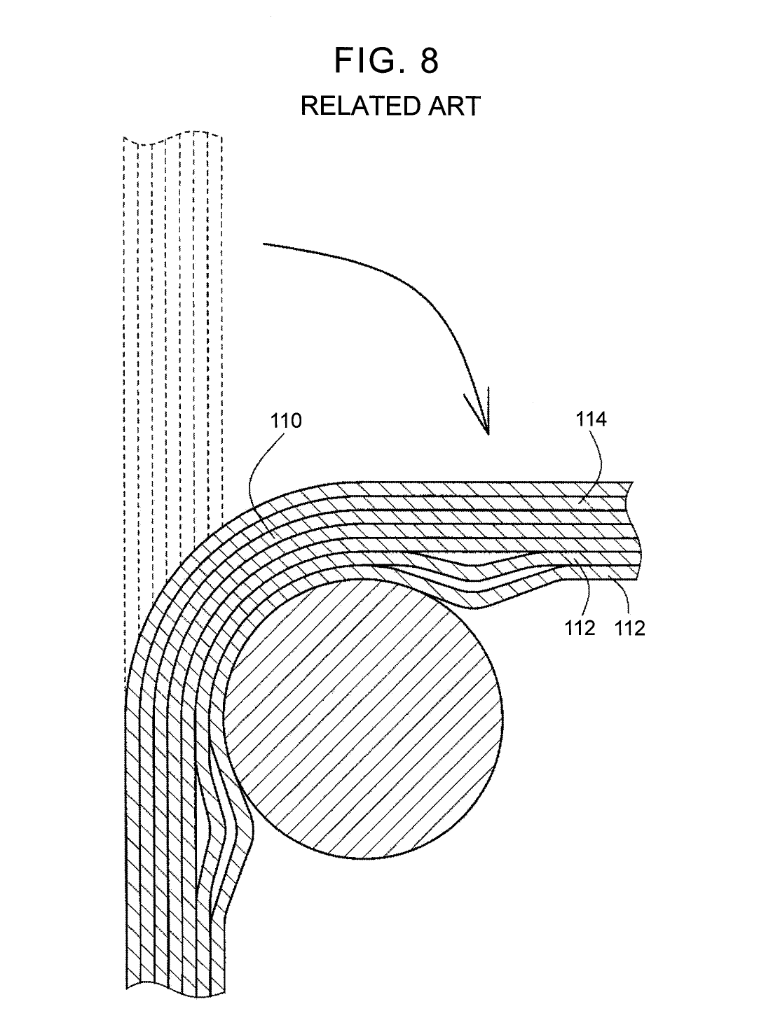

### DETAILED DESCRIPTION OF EMBODIMENTS

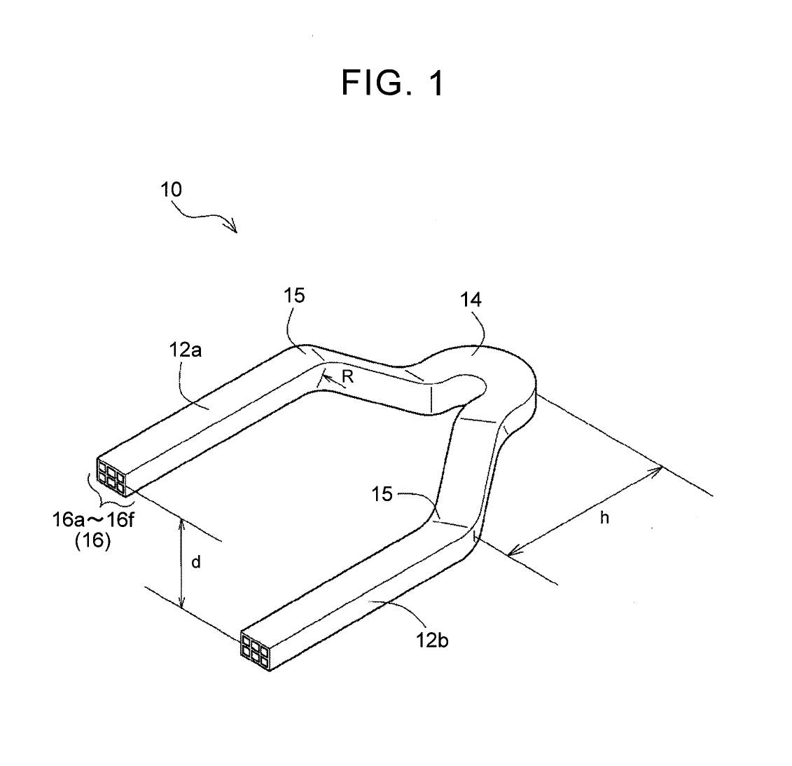

FIG. 1 is a view of a segment coil 10 according to one example embodiment of the invention. The segment coil 10 includes a pair of leg portions 12a and 12b, and a folded-back portion 14.

The leg portions 12a and 12b, are inserted in a stator axial direction between teeth of a stator core, not shown. The leg portions 12a and 12b are formed longer than the depth of teeth in the stator axial direction. Therefore, when the segment coil 10 is inserted between the teeth, the tip end of each of the leg portions 12a and 12b protrudes out from between the teeth. This protruding portion is connected by welding or the like to a leg portion of another segment coil. In this way, a plurality of segment coils are connected together to form a series of coils. Also, the leg portions 12a and 12b are formed separated by a distance d, thus enabling them to each be inserted between different teeth.

The folded-back portion 14 is a portion that connects the leg portions 12a and 12b together. When the segment coil 10 is inserted between the teeth of the stator core, the folded-back portion 14 becomes a coil end that protrudes out from the stator core. The protrusion amount of the coil end, i.e., a height h of the folded-back portion 14, is determined according to a bending radius R of a bent portion 15 that is at the base of the folded-back portion 14. For example, the height h of the folded-back portion 14 becomes lower as the bending radius R becomes smaller. That is, the protrusion amount of the coil end decreases as the bending radius R becomes smaller.

The segment coil 10 is formed by a wire assembly 16 in which a plurality of conducting wires 16a to 16f are bundled together. Each of the conducting wires 16a to 16f is insulation coated so as to inhibit conduction with adjacent conducting wires. Breaking up the conducting wires in this way makes it possible to reduce eddy current loss when current flows through the segment coil 10.

Also, the segment coil 10 is formed so as to be a so-called flat wire that has a rectangular cross-section. Making the segment coil 10 have a fiat, wire shape makes it possible to improve the proportion of conductor (i.e., the space factor) in the teeth, compared to a so-called round wire that has a circular cross-section.

Next, a manufacturing method of the segment coil 10 according to the example embodiment will be described. The manufacturing method of the segment coil 10 includes a bundling step, a bending step, a compression molding step, and a coating step.

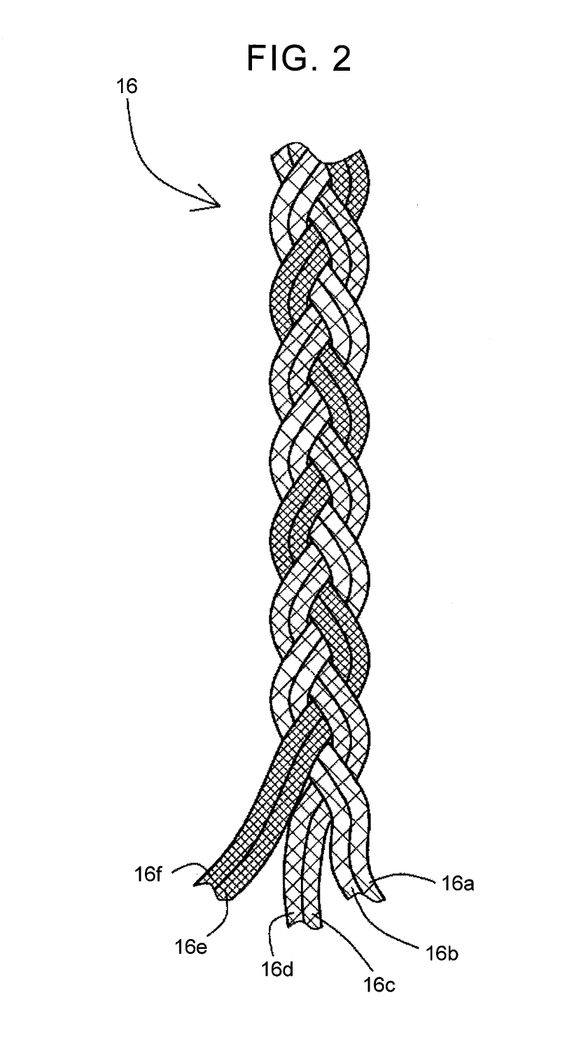

In the bundling step, the plurality of conducting wires 16a to 16f are bundled to form the wire assembly 16, as shown in FIG. 2. Here, the wire assembly 16 is formed by loosely twisting the plurality of conducting wires 16a to 16f together. In other words, the plurality of conducting wires 16a to 16f are loosely twisted together so that they are able to slide with respect to one another.

The twisting pattern may be a three-strand braided pattern as in the example shown in FIG. 2. The twisting pattern may also be a two-strand braided pattern or a four-strand braided pattern, instead of a three-strand braided pattern. Also, when the six strands of conducting wire 16a to 16f are braided in a three-strand braid, the conducting wires may be paired into three pairs of two, and the three pairs may be braided together, as shown in the example in FIG. 2.

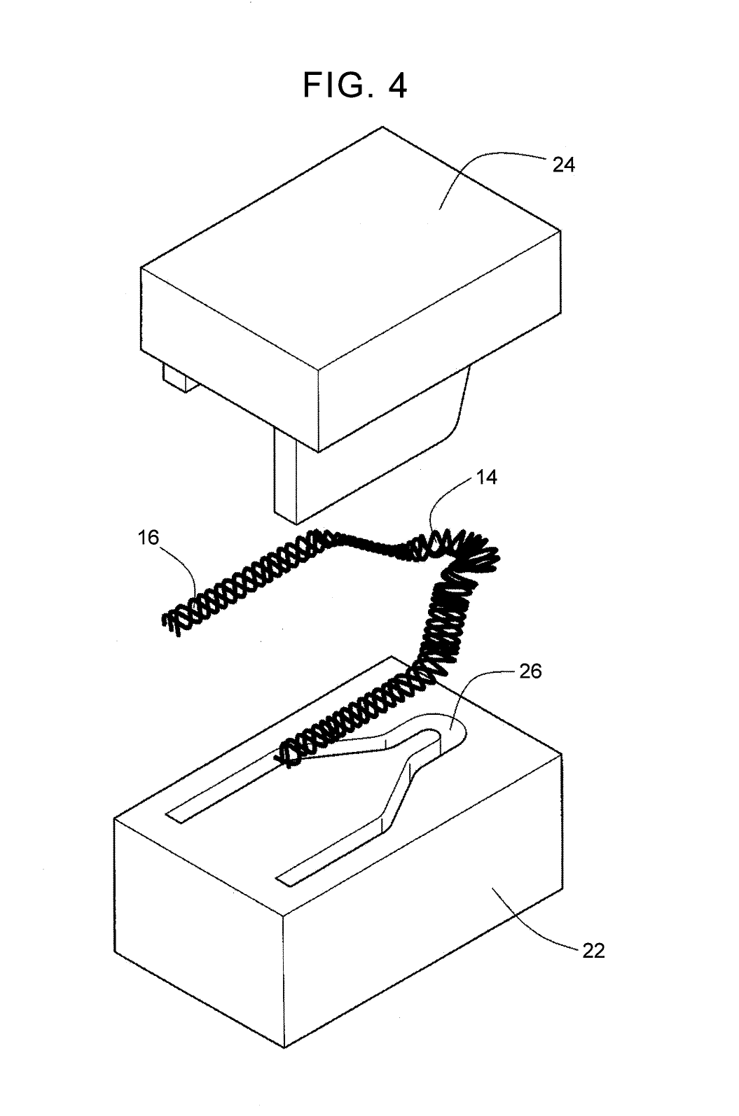

In the bending step, the wire assembly 16 is bent into a predetermined shape. For example, the wire assembly 16 is formed in the general shape of the segment coil 10, so as to be a shape that is able to be inserted into a forming die 26 of a die (a recessed tool) 22 of a pressing machine shown in FIG. 4, that will be described later.

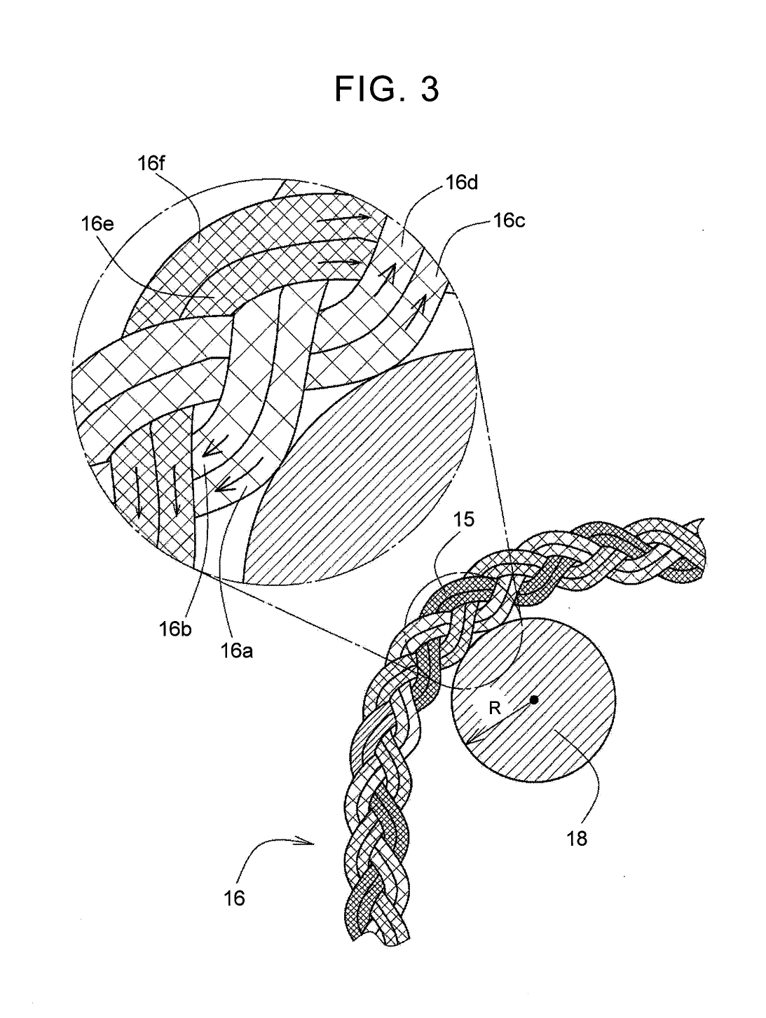

In the bending process, the wire assembly 16 is bent along a bending pin 18, as shown in FIG. 3, for example. When forming the bent portion 15 of the segment coil 10 shown in FIG. 1, the radius of the bending pin 18 is formed to be the bending radius R of the bent portion 15.

As described above, with the wire assembly 16 according to this example embodiment, the plurality of conducting wires 16a to 16f are twisted together so as to be able to slide with respect to one another. Therefore, when the wire assembly 16 is bent in the bending process, the plurality of conducting wires 16a to 16f slide with respect to each other so as to reduce bending stress. For example, the conducting wires 16a to 16d on the inner peripheral side move (i.e., run out) to the outer peripheral side from compression stress. Also, the conducting wires 16e and 16f on the outer peripheral side pull themselves in toward the bent portion 15 side from tensile stress.

In this way, in this example embodiment, the individual conducting wires are not fixed at the time the bending process is performed, so when the wire assembly 16 is bent, the conducting wires 16a to 16f slide with respect to each other, so bending stress is reduced. This reduction in bending stress makes it possible to inhibit the conducting wires on the inner peripheral side from buckling, even when the bending radius R of the bent portion 15 is small.

Further, the plurality of conducting wires 16a to 16f are twisted together, so the wire assembly 16 is prevented from coming apart into the individual conducting wires 16a to 16f even before the conducting wires 16a to 16f are fixed.

In the compressing step, compression molding is performed using the die 22 and a punch 24 in the shape of the segment coil 10, as shown in FIG. 4. The wire assembly 16 formed in the general shape of the segment coil 10 in the bending process is arranged in the forming die 26 of the die 22 and compression molded. Adjacent conducting wires are fixed together by this compression molding.

In the coating step, an outer peripheral surface of the wire assembly 16 after compression molding is coated with an insulating film. An insulation coating coated on the individual conducting wires 16a to 16f may peel off in during compression molding, so the conductor exposed on the outer peripheral surface of the wire assembly 16 is coated in this coating step. This coating process may be performed by dipping (dip coating), for example.

While the invention has been described with reference to exemplary embodiments thereof, it is to be understood that the invention is not limited to the exemplary embodiments or constructions. To the contrary, the invention is intended to cover various modifications and equivalent arrangements. In addition, while the various elements of the exemplary embodiments are shown in various combinations and configurations, which are exemplary, other combinations and configurations, including more, less or only a single element, are also within the spirit and scope of the invention.

What is claimed is:

1. A manufacturing method of a segment coil, comprising:
bending a wire assembly in which a plurality of conducting wires are twisted together in a manner such that the conducting wires are able to slide with respect to one another; and
compression molding the bent wire assembly.

2. The manufacturing method according to claim 1, further comprising:
coating the compression molded wire assembly with an insulating film.
